(19) United States
(12) Patent Application Publication
(10) Pub. No.: US 2024/0403421 A1
(43) Pub. Date: Dec. 5, 2024

(54) TRANSMITTING DATA FOR DETECTING SUSPICIOUS ACTIVITY BY AN ELECTRONIC LOCK

(71) Applicant: ASSA ABLOY AB, Stockholm (SE)

(72) Inventors: Tomas Jonsson, Rönninge (SE); Lars Lindroth, Hässelby (SE)

(21) Appl. No.: 18/699,745

(22) PCT Filed: Oct. 20, 2022
(86) PCT No.: PCT/EP2022/079179

§ 371 Date: Apr. 9, 2024

(30) Foreign Application Priority Data
Oct. 21, 2021 (SE) 2151287-6

(51) Int. Cl. G06F 21/55

(52) U.S. Cl. CPC G06F 21/554; G06F 2221/034

(57) ABSTRACT

It is provided a method for enabling detecting suspicious activity by an electronic lock (2). The method comprises: obtaining (40) communication data being metadata of communication to and/or from the electronic lock (2); obtaining (42) internal state data being metadata of an internal state of the electronic lock; obtaining (44) event data indicating at least one event and a time of for the event, wherein the event has occurred for the electronic lock; and transmitting (46) the communication data, the internal state data and the event data to a monitoring server (3). Corresponding electronic lock (2), monitoring server (3), computer programs (67, 167, 91) and computer program products (64, 164, 90) are also provided.

### TECHNICAL FIELD

The present disclosure relates to the field of detecting suspicious activity by electronic locks and in particular to transmitting data for detecting suspicious activity by an electronic lock.

### BACKGROUND

Locks and keys are evolving from the traditional pure mechanical locks. These days, electronic locks are becoming increasingly common. For electronic locks, no mechanical key profile is needed for authentication of a user. The electronic locks can e.g. be opened using an electronic key stored on a special carrier (fob, card, etc.) or in a smartphone. The electronic key and electronic lock can e.g. communicate over a wireless interface. Such electronic locks provide a number of benefits, including improved flexibility in management of access rights, audit trails, key management, etc.

When electronic locks are online locks, electronic locks have been provided with network access. The network access can be used for the electronic lock to report data and/or to allow control of the device by another device.

Electronic locks are often resource constrained in terms of power supply, memory size, processing power, etc. For a hacker, the great increase in electronic locks provides new opportunities of gaining control, not only of the electronic lock itself, which can compromise not only cybersecurity but also physical security. Such control can be gained if the hacker somehow manages to make the electronic lock 2 execute malicious code introduced or patched together by the hacker.

### SUMMARY

One object is to improve ability to detect that suspicious activity, such as malicious code, is executing on an electronic lock.

According to a first aspect, it is provided a method for enabling detecting suspicious activity by an electronic lock. The method is performed by the electronic lock. The method comprises: obtaining communication data being metadata of communication to and/or from the electronic lock; obtaining internal state data being metadata of an internal state of the electronic lock; obtaining event data indicating at least one event and a time of for the event, wherein the event has occurred for the electronic lock, wherein the event is an externally invoked function of the electronic lock, and the invoked function is an unlock event, a lock event, a barrier open event, or a barrier closed event; and transmitting the communication data, the internal state data and the event data to a monitoring server.

The internal state data may be based on a size indicator of a call stack of the electronic lock. In one embodiment, the internal state data comprises the size indicator of a call stack of the electronic lock.

The internal state data may be based on an indicator of distance between return addresses in the call stack of the electronic lock. In one embodiment, the internal state data comprises the indicator of distance between return addresses in the call stack of the electronic lock.

The internal state data may be based on an entropy indicator of the call stack of the electronic lock. In one embodiment, the internal state data comprises the entropy indicator of the call stack of the electronic lock.

The internal state data may be based on metadata of heap memory allocations of the electronic lock. In one embodiment, the internal state data comprises the metadata of heap memory allocations of the electronic lock.

The method may be performed as part of a checkpoint code routine, which is invoked by other software code of the electronic lock.

The communication data may comprise an address of other communication entity and a timestamp.

According to a second aspect, it is provided electronic lock for transmitting data for detecting suspicious activity by the electronic lock. The electronic lock comprises: a processor; and a memory storing instructions that, when executed by the processor, cause the electronic lock to: obtain communication data being metadata of communication to and/or from the electronic lock; obtain internal state data being metadata of an internal state of the electronic lock; obtain event data indicating at least one event and a time of for the event, wherein the event has occurred for the electronic lock, wherein the event is an externally invoked function of the electronic lock, and the invoked function is an unlock event, a lock event, a barrier open event, or a barrier closed event; and transmit the communication data, the internal state data and the event data to a monitoring server.

The internal state data may be based on a size indicator of a call stack of the electronic lock.

The internal state data may be based on an indicator of distance between return addresses in the call stack of the electronic lock.

The internal state data may be based on an entropy indicator of the call stack of the electronic lock.

The internal state data may be based on metadata of heap memory allocations of the electronic lock.

The memory may comprise instructions that, when executed by the processor, cause the electronic lock to invoke the checkpoint code routine in software code of the electronic lock.

The communication data may comprise an address of other communication entity and a timestamp.

According to a third aspect, it is provided a computer program for transmitting data for detecting suspicious activity by the electronic lock. The computer program comprises computer program code which, when executed on an electronic lock causes the electronic lock to: obtain communication data being metadata of communication to and/or from the electronic lock; obtain internal state data being metadata of an internal state of the electronic lock; obtain event data indicating at least one event and a time of for the event, wherein the event has occurred for the electronic lock, wherein the event is an externally invoked function of the electronic lock, and the invoked function is an unlock event, a lock event, a barrier open event, or a barrier closed event; and transmit the communication data, the internal state data and the event data to a monitoring server.

According to a fourth aspect, it is provided a computer program product comprising a computer program according to the third aspect and a computer readable means comprising non-transitory memory in which the computer program is stored.

According to a fifth aspect, it is provided a method for enabling detecting suspicious activity by an electronic lock. The method is performed by a monitoring server. The method comprises: receiving communication data, internal state data and event data from an electronic lock, wherein the communication data is metadata of communication to and/or from the electronic lock, the internal state data is metadata of an internal state of the electronic lock, and the event data indicates at least one event and a time of for the event, wherein the event has occurred for the electronic lock, wherein the event is an externally invoked function of the electronic lock, and the invoked function is an unlock event, a lock event, a barrier open event, or a barrier closed event; and determining that suspicious activity is performed by the electronic lock based on the communication data, internal state data and event data.

The receiving communication data may be performed for multiple electronic locks; in which case the determining that suspicious activity is performed is based on the communication data, internal state data and event data from multiple electronic locks.

The determining that suspicious activity is performed may comprise evaluating, based on the internal state data, that at least one return address in the call stack of the electronic lock is outside an allowed address range.

The determining that suspicious activity is performed may comprise evaluating, based on the internal state data, that a value of function pointers changes abnormally.

The determining that suspicious activity is performed may comprise monitoring a number of invalid messages that are being processed.

The determining that suspicious activity is performed may comprise evaluating at least one of durations of sleep periods, increased power consumption, frequency of rebooting, and response time duration.

According to a sixth aspect, it is provided monitoring server for enabling detecting suspicious activity by an electronic lock. The monitoring server comprises: a processor; and a memory storing instructions that, when executed by the processor, cause the monitoring server, to: receive communication data, internal state data and event data from an electronic lock, wherein the communication data is metadata of communication to and/or from the electronic lock, the internal state data is metadata of an internal state of the electronic lock, and the event data indicates at least one event and a time of for the event, wherein the event has occurred for the electronic lock, wherein the event is an externally invoked function of the electronic lock, and the invoked function is an unlock event, a lock event, a barrier open event, or a barrier closed event; and determine that suspicious activity is performed by the electronic lock based on the communication data, internal state data and event data.

The instructions to receive communication data may be performed for multiple electronic locks; in which case the instructions to determine that suspicious activity is performed comprise instructions that, when executed by the processor, cause the monitoring server, to determine the suspicious activity based on the communication data, internal state data and event data from multiple electronic locks.

The instructions to determine that suspicious activity is performed may comprise instructions that, when executed by the processor, cause the monitoring server, to evaluate, based on the internal state data, that at least one return address in the call stack of the electronic lock is outside an allowed address range.

The instructions to determine that suspicious activity is performed may comprise instructions that, when executed by the processor, cause the monitoring server, to evaluate, based on the internal state data, that a value of function pointers changes abnormally.

The instructions to determine that suspicious activity is performed may comprise instructions that, when executed by the processor, cause the monitoring server, to monitor a number of invalid messages that are being processed.

The instructions to determine that suspicious activity is performed may instructions that, when executed by the processor, cause the monitoring server, to evaluate at least one of durations of sleep periods, increased power consumption, frequency of rebooting, and response time duration.

According to a seventh aspect, it is provided a computer program for enabling detecting suspicious activity by an electronic lock. The computer program comprises computer program code which, when executed on a monitoring server, causes the monitoring server, to: receive communication data, internal state data and event data from an electronic lock, wherein the communication data is metadata of communication to and/or from the electronic lock, the internal state data is metadata of an internal state of the electronic lock, and the event data indicates at least one event and a time of for the event, wherein the event has occurred for the electronic lock, wherein the event is an externally invoked function of the electronic lock, and the invoked function is an unlock event, a lock event, a barrier open event, or a barrier closed event; and determine that suspicious activity is performed by the electronic lock based on the communication data, internal state data and event data.

According to an eighth aspect, it is provided a computer program product comprising a computer program according to the seventh aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a schematic diagram illustrating components of the electronic lock of FIG. 1 according to one embodiment;

FIG. 3 is a schematic diagram illustrating memory structure of the memory of the electronic lock of FIG. 2;

FIG. 4 is a flow chart illustrating embodiments of methods for transmitting data for detecting suspicious activity by an electronic lock; and

FIG. 5 is a flow chart illustrating embodiments of methods for enabling detecting suspicious activity;

FIG. 5 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Embodiments presented herein are based on reporting from one or more electronic locks to a monitoring server for detecting suspicious activity by the electronic lock, such as malicious code executing in the electronic lock. This is enabled by the electronic lock collecting three types of data and providing this data to the monitoring server. The data includes communication metadata (e.g. end-point addresses and timestamps of communication packets), internal state data (e.g. relating to the state of a call stack and/or heap memory in the electronic lock) and event data (e.g. relating to functional events performed by the electronic lock). Based on this data, the monitoring device can detect suspicious activity by the electronic lock in a better way than what is possible in the prior art.

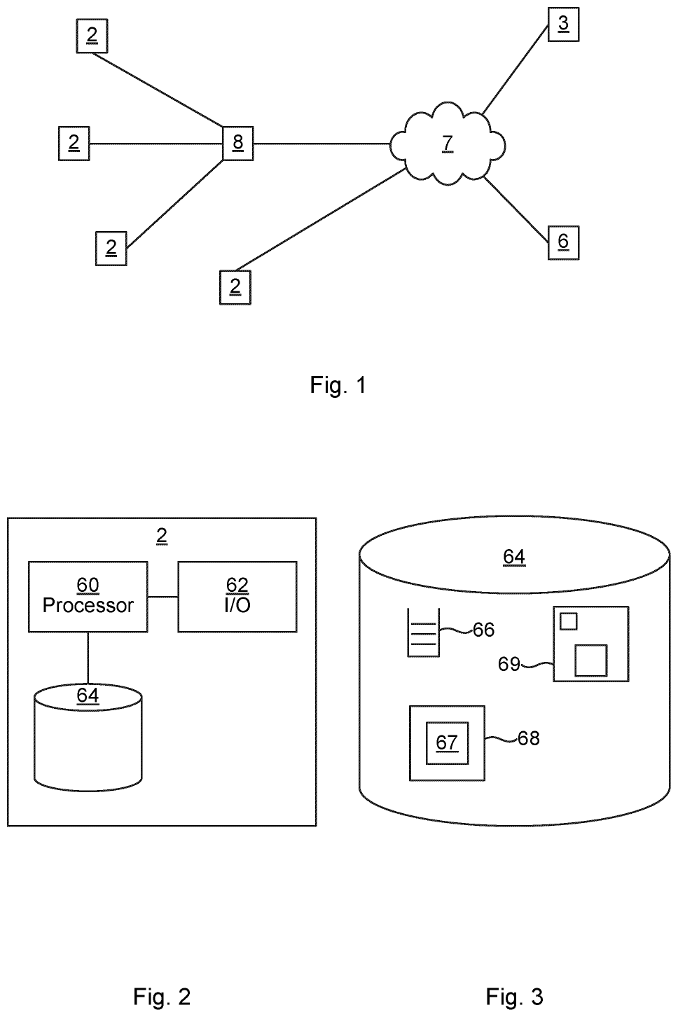

FIG. 1 is a schematic diagram illustrating an environment in which embodiments presented herein can be applied.

A number of electronic locks 2 are provided. The electronic lock is used to secure access by selectively controlling the locked/unlocked status of an associated openable barrier. The openable barrier can e.g. be a door, window, gate, hatch, drawer, etc. The electronic lock can then detect events such as an unlock event, a lock event, a barrier open event, or a barrier closed event.

Each electronic lock 2 is connected to a network 7, which can be an internet protocol (IP) based network. The network can e.g. comprise any one or more of a local wireless network (LAN), a cellular network, a wired local area network, a wide area network (such as the Internet), etc. The connection between each electronic lock 2 and the network 7 can be direct or optionally via a gateway 8. When the gateway 8 is utilised, the communication between the electronic lock 2 and the gateway can be based on any suitable protocol, e.g. Zigbee, BLE (Bluetooth Low Energy), etc.

A monitoring server 3 is provided, also connected to the network 7. The monitoring server 3 receives data from the electronic locks 2, as described in more detail below. Based on this data, the monitoring server 3 can in many cases detect when suspicious activity occurs on an electronic lock 2, e.g. due to malicious code executing on the electronic lock 2. The monitoring server 3 can be any suitable computer that can analyse the data provided from the electronic locks 2 for detecting suspicious activity. The monitoring server 3 can be provided at the same site as the electronic locks 2 or at any other site as long as there is a connection with the network 7. The monitoring server 3 can be combined in a computer that also performs other functions.

A malicious computer 6 can also be connected to the network 7, attempting to make one or more of the electronic locks 2 execute malicious code and/or communicate data between a compromised the electronic lock 2 and the malicious computer 6.

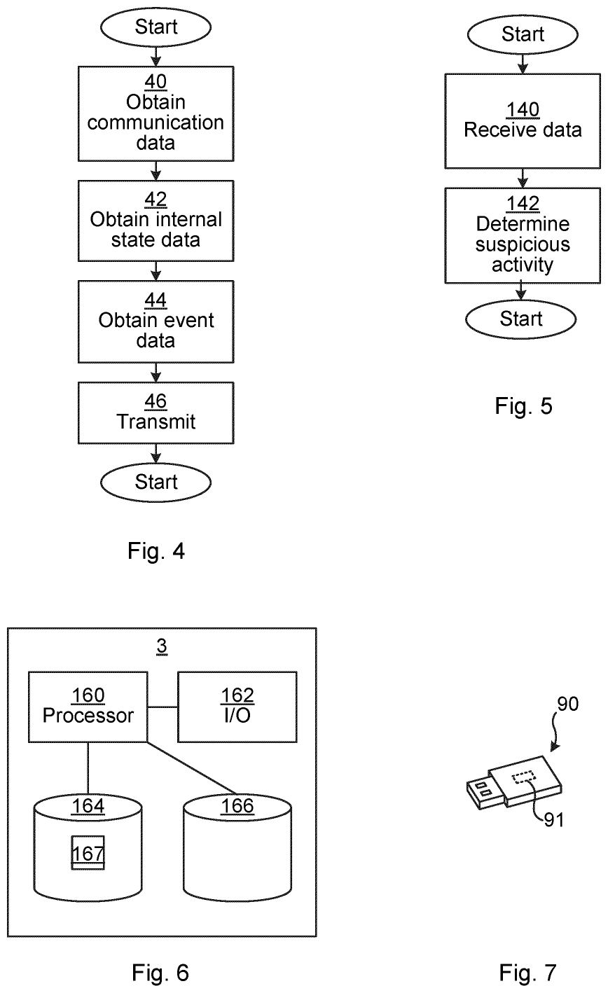

FIG. 2 is a schematic diagram illustrating components of the electronic lock of FIG. 1 according to one embodiment. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory. The memory can thus be considered to be a computer program product. The processor 60 can be configured to execute the method described with reference to FIG. 4 below.

The electronic lock 2 further comprises an I/O interface 62 for communicating with external and/or internal entities, e.g. for communication with the monitoring device 3 via the network 7.

Other components of the electronic lock 2 are omitted in order not to obscure the concepts presented herein.

FIG. 3 is a schematic diagram illustrating memory structure of the memory of the electronic lock of FIG. 2. Physically, the memory 64 can be made up of a single memory device or multiple memory devices, e.g. one chip for random-access memory (RAM) and one solid-state memory chip.

Functionally, the memory 64 comprises a call stack 66, being a last-in-first-out (LIFO) data structure. The call stack 66 is part of the RAM of the electronic lock 2 and is thus both readable and writable memory and is volatile memory. A key function of the call stack is when subroutines are called in program code execution. When a subroutine is called, a return address of the calling program code is pushed to the call stack 66. The call stack 66 can also hold local variable values and/or parameter values passed from the calling program code. There can be one call stack 66 for each execution thread (thread, process, etc.) executing in the processor 60.

The memory 64 further comprises a heap memory 69 is used as a data memory for program code executing in the electronic lock 2. This is implemented by the processor 60 allocating and deallocating memory chunks in the heap memory 69 as needed. The heap memory 69 is part of the RAM of the electronic lock 2 and is thus both readable and writable memory and can be volatile memory. The call stack 66 and the heap memory 69 can be implemented as different address ranges within the same RAM.

Furthermore, the memory can contain global variables that can be statically allocated, but whose contents can vary during run-time.

A non-transitory memory 68 comprises software instructions 67, also known as computer program code, which can be executed by the processor 60, e.g. to perform embodiments of the method described below with reference to FIG. 4. The non-transitory memory can be implemented using any single one or combination of solid-state memory, magnetic memory, optical memory, or even remotely mounted memory. Optionally, the non-transitory memory 68 is read-only memory (ROM) to reduce the risk of an attacker introducing malicious code in the electronic lock 2.

FIG. 4 is a flow chart illustrating embodiments of methods for transmitting data for detecting suspicious activity by an electronic lock 2, e.g. malicious code executing on the electronic lock 2. The method is performed by the electronic lock 2.

The method can be performed as part of a checkpoint code routine, which is invoked by other software code of the electronic lock 2. For instance, the checkpoint code routing can be invoked when an event occurs, such as unlocking a lock, locking a lock, opening a door, and/or closing a door. The checkpoint routine can be called from legitimate program code or malicious code executing in the electronic lock 2. While malicious code might not call the checkpoint code routine, by calling the checkpoint code routing sufficiently often prior to the malicious code gaining control over the electronic lock 2, suspicious activity can often be caught when the malicious code is in the process of being installed or initialised. Additionally, if the monitoring server detects that the checkpoint code routine no longer executes for the electronic lock 2 or that the checkpoint code routing is executed in another pattern than before, this can indicate malicious code being executed (or that the electronic lock 2 has failed).

In an obtain communication data step 40, the electronic lock 2 obtains communication data, being metadata of communication to and/or from the electronic lock 2. For instance, the communication data can comprise either or both addresses of end points of the communication and a timestamp. The communication data can also comprise other metadata of communication, such as packet size, etc. In this way, communication with a malicious computer 6 by the electronic lock 2 is indicated in the communication data, e.g. for downloading malicious code from the malicious computer 6 or sending data to the malicious computer 6, and can thus be detected by the monitoring server 3. Optionally, the communication data can also be based on communication related to neighbouring electronic locks, observable by the electronic lock 2.

In an obtain internal state data step 42, the electronic lock 2 obtains internal state data being metadata of an internal state of the electronic lock. For instance, the internal state data can indicate a state of various aspects of the memory in the electronic lock.

In one embodiment, the internal state data is based on (or comprises) a size indicator of a call stack 66 of the electronic lock 2 (e.g. a stack pointer). By enabling the monitoring server to evaluate the size of the stack, some types of malicious code in the electronic lock 2 can be detected. For instance, if malicious code results in many more subroutine calls in the electronic lock than when legitimate program code is executed, this can be detected by the call stack being unusually large.

Alternatively or additionally, the internal state data is based on (or comprises) an indicator of distance between return addresses in the call stack of the electronic lock 2. This can be expressed as an array of distances, between consecutive return addresses, an average distance between consecutive return addresses (either of the entire call stack or of the top-most n number of return addresses on the stack). The monitoring server 3 can then e.g. see if the distance between return addresses is large, which can be an indicator of malicious code in the call stack. Alternatively or additionally, the indicator of distance can be calculated as an indicator or variance of distances, e.g. as a standard deviation of distances. When normal, legitimate, code is executing, the distances can be relatively consistent compared to when malicious code is executing.

Alternatively or additionally, internal state data is based on (or comprises) an entropy indicator of the call stack of the electronic lock 2. The entropy indicator indicates how unordered, or apparently random, a set of data is. For instance, a set of data with random numbers has a greater entropy than a set of data with identical numbers. A decrease in entropy can indicate that malicious executable code has been written to the stack memory, e.g. by introducing a so-called NOP-sled in the stack memory.

Alternatively or additionally, the internal state data is based on (or comprises) the return addresses on the call stack. When provided to the monitoring server, the return addresses can be analysed to see if they are of an expected pattern or of a pattern that indicate an ROP (Return-oriented programming) gadget attack. In an ROP gadget attack, the hacker constructs malicious code by assembling legitimate subroutine code snippets to gain a desired result. The execution of these snippets is controlled by manipulating the return addresses on the call stack. The analysis of the return addresses can also be based on predefined rules defining what subroutines are allowed to be called by each section of program code. If there is violation to such rules, this indicates the execution of malicious code.

Alternatively or additionally, the internal state data is based on (or comprises) metadata of heap memory allocations of the electronic lock 2. This metadate of heap memory allocation can e.g. include any one or more of timestamp of allocation, start address of allocated memory chunk in the heap memory, size of allocated memory chunk, end address of allocated memory chunk, etc. An unusual allocation of heap memory (in terms of allocated memory chunk size or frequency of allocation) can be an indication of malicious code execution.

Alternatively or additionally, the internal state data is based on global variable values, in memory that can be statically allocated. In one embodiment, the internal state data comprises an indicator of the global variable values, e.g. as an indicator that is calculated based on the global variable values.

Alternatively or additionally, the internal state data comprises metadata of any one or more of the mentioned sources of the internal state data. For instance, such metadata can indicate frequency of change of a variable (optionally between each pair of corresponding events), whether the variable is within or outside a predefined acceptable range, etc.

In an obtain event data step 44, the electronic lock 2 obtains event data indicating at least one event and a time of for the event, wherein the event has occurred for the electronic lock. The event is an externally invoked function of the electronic lock 2, such as any one of an unlock event or a lock event, e.g. invoked by a user or predefined rule.

When the event occurs, since the internal state data and communication metadata is also captured, the internal state data and/or the communication metadata can be compared with other occasions that the same event has occurred in the past. When the difference in communication and/or internal state data is significant, this can indicate that malicious code is executed on the electronic lock 2.

In a transmit step 46, the electronic lock 2 transmits the communication data, the internal state data and the event data to the monitoring server 3 (over the network 7). Optionally, the electronic lock determines a smaller set of representative data based on the communication data, the internal state data and the event data. For instance, the electronic lock can perform feature extraction, resulting in a reduced set of data. The features can then be considered a type of signature of a current state of the electronic lock 2.

This allows the monitoring server 3 to evaluate the three sets of data individually and/or in concert. If the monitoring server 3 detects suspicious activity, this can trigger one or more actions to reduce or eliminate the effects of the malicious code. For instance, the affected electronic lock 2 with malicious code can be disconnected from the network 7 to prevent the hacker from gaining access to other electronic locks on the same local network.

It is to be noted that steps 40, 42 and 44 can be performed in any order as long as all three steps are performed prior to step 46.

Using embodiments presented herein, suspicious activity in electronic locks can be detected. The reporting can be tailored to the capabilities of the particular electronic lock, providing a balance between detection ability and resource use. Hence, the embodiments presented herein can be applied also for resource-constrained devices such as IoT devices. The monitoring server can use all the data from the electronic lock as input to a trained machine learning model to evaluate when it is likely that suspicious activity occurs.

FIG. 5 is a flow chart illustrating embodiments of methods for enabling detecting suspicious activity by an electronic lock 2. The method is performed by the monitoring server 3. It is the monitoring server that performs data processing of the data from the electronic locks to detect suspicious activity.

In a receive data step 140, the monitoring server 3 receives communication data, internal state data and event data from an electronic lock 2. As explained above, the communication data is metadata of communication to and/or from the electronic lock 2. The internal state data is metadata of an internal state of the electronic lock. The event data indicates at least one event and a time of for the event, wherein the event has occurred for the electronic lock. More specifically, the event is an externally invoked function of the electronic lock 2, and the invoked function is an unlock event, a lock event, a barrier open event, or a barrier closed event.

Optionally, the communication data is received from multiple electronic locks 2.

In a determine suspicious activity step 142 the monitoring server 3 determines that suspicious activity is performed by the electronic lock 2 based on the communication data, internal state data and event data.

This determination can be based on rules and/or based on a machine learning model, e.g. a neural network. When the electronic locks 2 reduce the amount of data to features, using feature extraction, the machine learning model can be based on these features as input.

When the data has been received for multiple electronic locks, the determining that suspicious activity is performed is based on the communication data, internal state data and event data from (the) multiple electronic locks 2. In this way, if any one or more of the data types from one electronic lock 2 deviates significantly from corresponding data from the other electronic locks, this is an indication of suspicious activity.

The determining that suspicious activity is performed can comprise evaluating, based on the internal state data, that at least one return address in the call stack of the electronic lock 2 is outside an allowed address range. For instance, the allowed address range (i.e. valid return addresses) can be defined as addresses within an address space for non-transitory (e.g. flash) memory, where legitimate code is stored. This processing will thus detect when suspicious code in RAM is attempted to be executed.

The determining that suspicious activity is performed can comprise evaluating, based on the internal state data, that a value of function pointers changes abnormally.

The determining that suspicious activity is performed can comprise monitoring a number of invalid messages that are being processed. The invalid message could be an indication of an attacking neighbouring electronic lock or attacking user device. An invalid message can e.g. be determined by an incorrect checksum, by decryption failing (due to encryption of the message using an incorrect key), by the message departing from an agreed communication protocol, incorrect addressing, etc.

The determining that suspicious activity is performed can comprise evaluating at least one of (for the electronic lock): durations of sleep periods, increased power consumption, frequency of rebooting, and response time duration.

FIG. 6 is a schematic diagram illustrating components of the monitoring server 3 of FIG. 1. A processor 160 is provided using any combination of one or more of a suitable central processing unit (CPU), graphics processing unit (GPU), multiprocessor, microcontroller, digital signal processor (DSP), etc., capable of executing software instructions 167 stored in a memory 164, which can thus be a computer program product. The processor 160 could alternatively be implemented using an application specific integrated circuit (ASIC), field programmable gate array (FPGA), etc. The processor 160 can be configured to execute the method described with reference to Fig monitoring server 3 above.

The memory 164 can be any combination of random-access memory (RAM) and/or read-only memory (ROM). The memory 164 also comprises non-transitory persistent storage, which, for example, can be any single one or combination of magnetic memory, optical memory, solid-state memory or even remotely mounted memory.

A data memory 166 is also provided for reading and/or storing data during execution of software instructions in the processor 160. The data memory 166 can be any combination of RAM and/or ROM.

The monitoring server 3 further comprises an I/O interface 162 for communicating with external and/or internal entities, such as with the electronic locks 2.

Other components of the monitoring server 3 are omitted in order not to obscure the concepts presented herein.

FIG. 7 shows one example of a computer program product comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIGS. 2 and 3 or the computer program product 164 of FIG. 6. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

Here now follows a list of embodiments enumerated with roman numerals.

i. A method for enabling detecting suspicious activity by an electronic device, the method being performed by the electronic device, the method comprising:
obtaining communication data being metadata of communication to and/or from the electronic device;
obtaining internal state data being metadata of an internal state of the electronic device;
obtaining event data indicating at least one event and a time of for the event, wherein the event has occurred for the electronic device; and
transmitting the communication data, the internal state data and the event data to a monitoring server.

ii. The method according to embodiment i, wherein the internal state data is based on a size indicator of a call stack of the electronic device.

iii. The method according to embodiment i or ii, wherein the internal state data is based on an indicator of distance between return addresses in the call stack of the electronic device.

iv. The method according to any one of the preceding embodiments, wherein the internal state data is based on an entropy indicator of the call stack of the electronic device.

v. The method according to any one of the preceding embodiments, wherein the internal state data is based on metadata of heap memory allocations of the electronic device.

vi. The method according to any one of the preceding embodiments, wherein the method is performed as part of a checkpoint code routine, which is invoked by other software code of the electronic device.

vii. The method according to any one of the preceding embodiments, wherein the event is an externally invoked function of the electronic device.

viii. The method according to embodiment vii, wherein the electronic device is an electronic lock, and the invoked function is an unlock event, a lock event, a barrier open event, or a barrier closed event.

ix. The method according to any one of the preceding embodiments, wherein the communication data is based on an address of other communication entity and a timestamp.

x. An electronic device for transmitting data for detecting suspicious activity by the electronic device, the electronic device comprising:
a processor; and
a memory storing instructions that, when executed by the processor, cause the electronic device to:
obtain communication data being metadata of communication to and/or from the electronic device;
obtain internal state data being metadata of an internal state of the electronic device;
obtain event data indicating at least one event and a time of for the event, wherein the event has occurred for the electronic device; and
transmit the communication data, the internal state data and the event data to a monitoring server.

xi. The electronic device according to embodiment x, wherein the internal state data is based on a size indicator of a call stack of the electronic device.

xii. The electronic device according to embodiment x or xi, wherein the internal state data is based on an indicator of distance between return addresses in the call stack of the electronic device.

xiii. The electronic device according to any one of embodiments x to xii, wherein the internal state data is based on an entropy indicator of the call stack of the electronic device.

xiv. The electronic device according to any one of embodiments x to xiii, wherein the internal state data is based on metadata of heap memory allocations of the electronic device.

xv. The electronic device according to any one of embodiments x to xiv, wherein the instructions are part of a checkpoint code routine, and wherein the memory comprises instructions that, when executed by the processor, cause the electronic device to invoke the checkpoint code routine in software code of the electronic device.

xvi. The electronic device according to any one of embodiments x to xv, wherein the event is an externally invoked function of the electronic device.

xvii. The electronic device according to embodiment xvi, wherein the electronic device is an electronic lock, and the invoked function is an unlock event, a lock event, a barrier open event, or a barrier closed event.

xviii. The electronic device according to any one of embodiments x to xvii, wherein the communication data comprises an address of other communication entity and a timestamp.

xix. A computer program for transmitting data for detecting suspicious activity by the electronic device, the computer program comprising computer program code which, when executed on an electronic device causes the electronic device to:
obtain communication data being metadata of communication to and/or from the electronic device;
obtain internal state data being metadata of an internal state of the electronic device;
obtain event data indicating at least one event and a time of for the event, wherein the event has occurred for the electronic device; and
transmit the communication data, the internal state data and the event data to a monitoring server.

xx. A computer program product comprising a computer program according to embodiment xix and a computer readable means comprising non-transitory memory in which the computer program is stored.

xxi. A method for enabling detecting suspicious activity by an electronic device, the method being performed by a monitoring server, the method comprising: receiving communication data, internal state data and event data from an electronic device, wherein the communication data is metadata of communication to and/or from the electronic device, the internal state data is metadata of an internal state of the electronic device, and the event data indicates at least one event and a time of for the event, wherein the event has occurred for the electronic device; and determining that suspicious activity is performed by the electronic device based on the communication data, internal state data and event data.

xxii. The method according to embodiment xxi, wherein the receiving communication data is performed for multiple electronic devices; and wherein the determining that suspicious activity is performed is based on the communication data, internal state data and event data from multiple electronic devices.

xxiii. The method according to embodiment xxi or xxii, wherein the determining that suspicious activity is performed comprises evaluating, based on the internal state data, that at least one return address in the call stack of the electronic device is outside an allowed address range.

xxiv. The method according to any one of embodiments xxi to xxiii, wherein the determining that suspicious activity is performed comprises evaluating, based on the internal state data, that a value of function pointers changes abnormally.

xxv. The method according to any one of embodiments xxi to xxiv, wherein the determining that suspicious activity is performed comprises monitoring a number of invalid messages that are being processed.

xxvi. The method according to any one of embodiments xxi to xxv, wherein the determining that suspicious activity is performed comprises evaluating at least one of durations of sleep periods, increased power consumption, frequency of rebooting, and response time duration.

xxvii. A monitoring server for enabling detecting suspicious activity by an electronic device, the monitoring server comprising:
a processor; and
a memory storing instructions that, when executed by the processor, cause the monitoring server, to:
receive communication data, internal state data and event data from an electronic device, wherein the communication data is metadata of communication to and/or from the electronic device, the internal state data is metadata of an internal state of the electronic device, and the event data indicates at least one event and a time of for the event, wherein the event has occurred for the electronic device; and
determine that suspicious activity is performed by the electronic device based on the communication data, internal state data and event data.

xxviii. The monitoring server according to embodiment xxvii, wherein the instructions to receive communication data is performed for multiple electronic devices; and
wherein the instructions to determine that suspicious activity is performed comprise instructions that, when executed by the processor, cause the monitoring server, to determine the suspicious activity based on the communication data, internal state data and event data from multiple electronic devices.

xxix. The monitoring server according to embodiment xxvii or xxviii, wherein the instructions to determine that suspicious activity is performed comprise instructions that, when executed by the processor, cause the monitoring server, to evaluate, based on the internal state data, that at least one return address in the call stack of the electronic device is outside an allowed address range.

xxx. The monitoring server according to any one of embodiments xxvii to xxix, wherein the instructions to determine that suspicious activity is performed comprise instructions that, when executed by the processor, cause the monitoring server, to evaluate, based on the internal state data, that a value of function pointers changes abnormally.

xxxi. The monitoring server according to any one of embodiments xxvii to xxx, wherein the instructions to determine that suspicious activity is performed comprise instructions that, when executed by the processor, cause the monitoring server, to monitor a number of invalid messages that are being processed.

xxxii. The monitoring server according to any one of embodiments xxvii to xxxi, wherein the instructions to determine that suspicious activity is performed instructions that, when executed by the processor, cause the monitoring server, to evaluate at least one of durations of sleep periods, increased power consumption, frequency of rebooting, and response time duration.

xxxiii. A computer program for enabling detecting suspicious activity by an electronic device, the computer program comprising computer program code which, when executed on a monitoring server, causes the monitoring server, to:
receive communication data, internal state data and event data from an electronic device, wherein the communication data is metadata of communication to and/or from the electronic device, the internal state data is metadata of an internal state of the electronic device, and the event data indicates at least one event and a time of for the event, wherein the event has occurred for the electronic device; and
determine that suspicious activity is performed by the electronic device based on the communication data, internal state data and event data.

xxxiv. A computer program product comprising a computer program according to embodiment xxxiii and a computer readable means comprising non-transitory memory in which the computer program is stored.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for enabling detecting suspicious activity by an electronic lock, the method being performed by the electronic lock, the method comprising:
obtaining communication data being metadata of communication at least one of to or from the electronic lock;
obtaining internal state data being metadata of an internal state of the electronic lock;
obtaining event data indicating at least one event and a time of the event, wherein the event has occurred for the electronic lock, wherein the event is an externally invoked function of the electronic lock and the invoked function is an unlock event, a lock event, a barrier open event, or a barrier closed event; and
transmitting the communication data, the internal state data, and the event data to a monitoring server.

2. The method according to claim 1, wherein the internal state data is based on a size indicator of a call stack of the electronic lock.

3. The method according to claim 1, wherein the internal state data is based on an indicator of distance between return addresses in a call stack of the electronic lock.

4. The method according to claim 1, wherein the internal state data is based on an entropy indicator of a call stack of the electronic lock.

5. The method according to claim 1, wherein the internal state data is based on metadata of heap memory allocations of the electronic lock.

6. The method according to claim 1, wherein the method is performed as part of a checkpoint code routine, which is invoked by other software code of the electronic lock.

7. The method according to claim 1, wherein the communication data is based on an address of a communication entity and a timestamp.

8. An electronic lock for transmitting data for detecting suspicious activity by the electronic lock, the electronic lock comprising:
a processor; and
a memory storing instructions that, when executed by the processor, cause the electronic lock to:
obtain communication data being metadata of communication at least one of to or from the electronic lock;
obtain internal state data being metadata of an internal state of the electronic lock;
obtain event data indicating at least one event and a time of the event, wherein the event has occurred for the electronic lock, wherein the event is an externally invoked function of the electronic lock, and the invoked function is an unlock event, a lock event, a barrier open event, or a barrier closed event; and
transmit the communication data, the internal state data, and the event data to a monitoring server.

9. The electronic lock according to claim 8, wherein the internal state data is based on a size indicator of a call stack of the electronic lock.

10. The electronic lock according to claim 8, wherein the internal state data is based on an indicator of distance between return addresses in a call stack of the electronic lock.

11. The electronic lock according to claim 8, wherein the internal state data is based on an entropy indicator of a call stack of the electronic lock.

12. The electronic lock according to claim 8, wherein the internal state data is based on metadata of heap memory allocations of the electronic lock.

13. The electronic lock according to claim 8, wherein the instructions are part of a checkpoint code routine, and wherein the memory comprises instructions that, when executed by the processor, cause the electronic lock to invoke the checkpoint code routine in software code of the electronic lock.

14. The electronic lock according to claim 8, wherein the communication data comprises an address of a communication entity and a timestamp.

15-22. (canceled)

23. A monitoring server for enabling detecting suspicious activity by an electronic lock, the monitoring server comprising:
a processor; and
a memory storing instructions that, when executed by the processor, cause the monitoring server, to:
receive communication data, internal state data, and event data from an electronic lock, wherein the communication data is metadata of communication at least one of to or from the electronic lock, the internal state data is metadata of an internal state of the electronic lock, and the event data indicates at least one event and a time of the event, wherein the event has occurred for the electronic lock, wherein the event is an externally invoked function of the electronic lock, and the invoked function is an unlock event, a lock event, a barrier open event, or a barrier closed event; and
determine that suspicious activity is performed by the electronic lock based on the communication data, the internal state data, and the event data.

24. The monitoring server according to claim 23, wherein:
the instructions to receive communication data are performed for multiple electronic locks; and
the instructions to determine that suspicious activity is performed comprise instructions that, when executed by the processor, cause the monitoring server to determine the suspicious activity based on the communication data, the internal state data, and the event data from the multiple electronic locks.

25. The monitoring server according to claim 23, wherein the instructions to determine that suspicious activity is performed comprise instructions that, when executed by the processor, cause the monitoring server to evaluate, based on the internal state data, that at least one return address in a call stack of the electronic lock is outside an allowed address range.

26. The monitoring server according to claim 23, wherein the instructions to determine that suspicious activity is performed comprise instructions that, when executed by the processor, cause the monitoring server to evaluate, based on the internal state data, that a value of function pointers changes abnormally.

27. The monitoring server according to claim 23, wherein the instructions to determine that suspicious activity is performed comprise instructions that, when executed by the processor, cause the monitoring server to monitor a number of invalid messages that are being processed.

28. The monitoring server according to claim 23, wherein the instructions to determine that suspicious activity is performed comprise instructions that, when executed by the processor, cause the monitoring server to evaluate at least one of durations of sleep periods, increased power consumption, frequency of rebooting, and response time duration.

29-30. (canceled)
